(19) United States
(12) Patent Application Publication
(10) Pub. No.: US 2022/0158544 A1
(43) Pub. Date: May 19, 2022

(54) POWER CONVERTER, REFRIGERATION CYCLE APPARATUS, AND AIR CONDITIONING APPARATUS

(71) Applicant: Mitsubishi Electric Corporation, Tokyo (JP)

(72) Inventors: Naoki YAMADA, Tokyo (JP); Kenta YUASA, Tokyo (JP); Shinya YANO, Tokyo (JP)

(21) Appl. No.: 17/598,682

(22) PCT Filed: Jun. 18, 2019
(86) PCT No.: PCT/JP2019/024085

§ 371 Date: Sep. 27, 2021

(51) Int. Cl. H02M 1/34; H02M 1/00; H02M 7/5387; H02P 27/08; H02M 7/00; H02M 1/44

(52) U.S. Cl. CPC H02M 1/348; H02M 1/0009; H02M 7/53871; F25B 2600/11; H02M 7/003; H02M 1/44; F25B 2600/021; H02P 27/08

(57) ABSTRACT

A power converter includes a plurality of inverter modules, each having a plurality of switching elements and each configured to convert a direct current voltage into an alternating current voltage by operations of the switching elements, a plurality of surge absorption circuits provided corresponding to the plurality of inverter modules and configured to absorb a generated surge voltage, and a plurality of current detection devices provided corresponding to the plurality of inverter modules, the current detection devices each having a current detection unit for detecting a current flowing in the corresponding inverter module.

### TECHNICAL FIELD

The present disclosure relates to a power converter having a switching element, and also relates to a refrigeration cycle apparatus and an air-conditioning apparatus.

### BACKGROUND ART

Hitherto, power converters, which rectify a power supplied from an alternating current (AC) power source into a direct current (DC) power by using a rectifier circuit and then convert again the power into an AC power of a predetermined frequency by using an inverter module, are known. Furthermore, some inverter modules are provided with a high-speed switching element, as typified by an insulated gate bipolar transistor (IGBT). A power converter that has an inverter unit in which a plurality of inverter modules of the same type, as circuit elements, are connected in parallel to form a circuit, and drives switching elements by a common driving signal is disclosed (see Patent Literature 1, for example). When a power converter is configured by connecting in parallel a plurality of inverter modules, each using a switching element of a small current capacity, the cost is reduced and the heat radiation is improved, compared with a case of driving a power converter configured by a single inverter module using a switching element of a large current capacity.

Meanwhile, when an inverter module is driven alone, a snubber circuit is provided so that an inductance energy of a circuit is released and a transitional high voltage generated when switching is interrupted is suppressed. Thus, a surge waveform is prevented from occurring. When a snubber circuit is provided, thereby suppressing a high voltage, a switching circuit itself and its peripheral circuit can be prevented from being damaged, and electromagnetic noise can be suppressed. For example, a power converter that drives an inverter module and in which both arm ends of each switching element in the inverter module are connected to a snubber capacitor is disclosed (see Patent Literature 2, for example).

### CITATION LIST

### Patent Literature

Patent Literature 1: Japanese Unexamined Patent Application Publication No. 2009-261106

Patent Literature 2: Japanese Unexamined Patent Application Publication No. 2003-250277

### SUMMARY OF INVENTION

### Technical Problem

However, when a plurality of inverter modules are used, as the power converter described in Patent Literature 1, the size of the device is increased. Consequently, wiring between the inverter modules and a capacitor, and pattern inductances due to the wiring are increased. At this time, a pattern inductance between one inverter module and the capacitor differs from that between another inverter module and the capacitor. Consequently, a noise resistance is reduced and malfunction occurs in a module internal circuit.

Furthermore, the power converter described in Patent Literature 2 is related to a device in which snubber circuits are installed in a single inverter module, and is not related to a device of driving a plurality of inverter modules in parallel. When a plurality of inverter modules are installed, the size of the device is increased and thus the length of wiring is increased. Consequently, the pattern inductances are increased and surge voltages are increased. In addition, depending on the arrangement positions of the inverter modules, the pattern inductance between each inverter module and a capacitor varies, thereby easily generating a difference in generated surge voltage. For this reason, in a case of a power converter in which a plurality of inverter modules are driven in parallel, consideration of a surge absorption circuit is required in particular. Here, as one technique for increasing the performance of a snubber circuit, a snubber circuit component having a large time constant may be adopted. However, due to an increase in the component mounting area and due to a decrease in lifetime of the snubber circuit component under a high load environment, the size and cost of the device are increased.

The present disclosure has been made to solve the above problems, and an object of the disclosure is to provide a power converter having a plurality of inverter modules, the power converter being capable of preventing malfunction of an internal circuit and increasing a reliability of the entire device while minimizing the size and cost of the device. Other objects of the present disclosure are to provide a refrigeration cycle apparatus and an air-conditioning apparatus.

### Solution to Problem

A power converter according to an embodiment of the present disclosure includes a plurality of inverter modules, each having a plurality of switching elements and each configured to convert a DC voltage into an AC voltage by operations of the switching elements, a plurality of surge absorption circuits provided corresponding to the plurality of inverter modules and configured to absorb a generated surge voltage, and a plurality of current detection devices provided corresponding to the plurality of inverter modules, the current detection devices each having a current detection unit for detecting a current flowing in the corresponding inverter module.

Furthermore, a refrigeration cycle apparatus according to another embodiment of the present disclosure includes the power converter described above, and at least one of a compressor and a fan is driven by a power converted by the power converter.

Moreover, an air-conditioning apparatus according to still another embodiment of the present disclosure performs cooling and heating of an air-conditioned space by the refrigeration cycle apparatus described above.

### Advantageous Effects of Invention

According to an embodiment of the present disclosure, a surge absorption circuit and a current detection device are provided for each inverter module. Even when an amount of wiring and pattern inductances of the wiring are increased because a plurality of inverter modules are provided in the power converter, the surge absorption circuit and the current detection device of each inverter module can be set corresponding to the wiring and the pattern inductance of the inverter module without increasing the size of the power converter. As a result, as the whole device, a noise resistance can be prevented from lowering and malfunction of a circuit can be prevented from occurring.

### BRIEF DESCRIPTION OF DRAWINGS

FIG. 1 is a diagram illustrating a configuration example of a system focusing on a power converter as a main feature according to Embodiment 1.

FIG. 2 is a diagram illustrating an internal configuration of an inverter module in the power converter according to Embodiment 1.

FIG. 3 is a diagram illustrating an example of a configuration of a current detection device according to Embodiment 1.

FIG. 4 is a diagram illustrating an earth point according to Embodiment 1.

FIG. 5 is a diagram illustrating an arrangement relationship between inverter modules and a control unit according to Embodiment 1.

FIG. 6 is a diagram illustrating a relationship of the inverter terminals in terms of their output terminals and terminal blocks according to Embodiment 1.

FIG. 7 is a diagram illustrating pattern inductances between a capacitor 1 and inverter modules in a power converter according to Embodiment 2.

FIG. 8 is a diagram illustrating a configuration of a surge absorption circuit according to Embodiment 3.

FIG. 9 is a diagram illustrating a current detection device in a power converter according to Embodiment 4.

FIG. 10 is a diagram illustrating a configuration example of an air-conditioning apparatus according to Embodiment 5.

### DESCRIPTION OF EMBODIMENTS

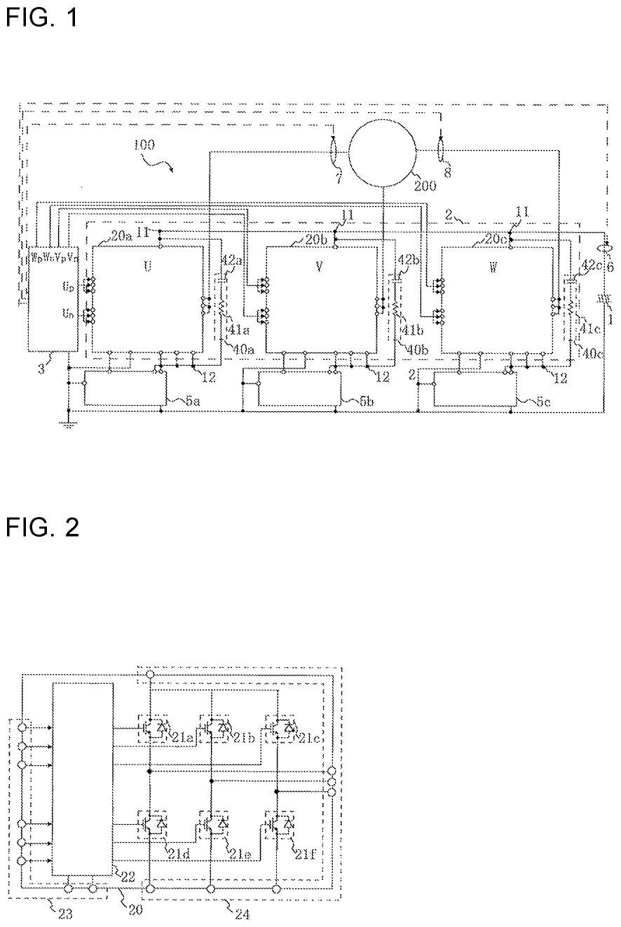

Embodiments will be described below with reference to the drawings. Note that in the accompanying drawings including FIG. 1, the components denoted by the same reference signs are the same or corresponding components, and the same applies hereinafter. Further, the modes of components described herein are merely illustrative, and the components are not limited to the modes described herein. In particular, combinations of the components are not limited to the combinations in embodiments, and components described in one embodiment may be applied to another embodiment. Furthermore, with regard to a plurality of devices of the same type which are distinguished by suffixes, in a case where the devices are not particularly required to be distinguished or specified, the suffixes are omitted in some cases. In addition, the relationship of sizes of the components in the drawings may differ from the actual sizes. Moreover, in terms of pressures and temperatures, the states of “high” and “low” are not determined by comparing with any specific absolute values, but are relatively determined based on conditions and operations in a system or a device.

### Embodiment 1

FIG. 1 is a diagram illustrating a configuration example of a system focusing on a power converter as a main feature according to Embodiment 1. As shown in FIG. 1, in the system according to Embodiment 1, a power converter 100 converts a power supplied from a power supply device (not shown) and supplies the converted power to a motor 200, which is an electric motor and is an object to which a power is supplied, to drive the motor 200. The power converter 100 includes a capacitor 1, an inverter unit 2, a control unit 3, surge absorption circuits 4 (surge absorption circuits 4a to 4c), and current detection devices 5 (current detection devices 5a to 5c). In this case, at least the inverter unit 2 and the surge absorption circuits 4 are mounted on one substrate, on which printed wiring is applied, by soldering or other attachment methods.

The capacitor 1 generates a DC voltage power by smoothing a power from the power supply device. The inverter unit 2 converts the DC voltage power smoothed by the capacitor 1 into an AC voltage power and supplies the AC voltage power to the motor 200 having three phases. The inverter unit 2 includes inverter modules 20 corresponding to the number of the phases of the motor 200. Here, an inverter module 20a corresponds to a U-phase of the motor 200. An inverter module 20b corresponds to a V-phase of the motor 200. An inverter module 20c corresponds to a W-phase of the motor 200. The inverter modules 20 each include a plurality of switching elements 21, as described later. An internal configuration of the inverter modules 20 will be described later.

Based on a voltage detected by a voltage detection unit 6 and motor currents detected by current detectors 7 and 8, the control unit 3 generates pulse width modulation (PWM) signals for driving and operating the inverter unit 2, and transmits the PVVM signals to the inverter unit 2 to control the inverter unit 2. Specifically, the control unit 3 generates a PVVM signal Up, a PWM signal Vp, a PWM signal Wp, a PWM signal Un, a PWM signal Vn, and a PWM signal Wn for controlling on-state or off-state of the switching elements for respective phases and arms, which will be described later, and then outputs the signals to the inverter unit 2. The PWM signals Up, Vp, and Wp control on-state or off-state in the switching elements 21 of an upper arm of the corresponding one of the U-phase, V-phase, and W-phase. The PWM signals Un, Vn, and Wn control on-state or off-state in the switching elements 21 of a lower arm of the corresponding one of the U-phase, V-phase, and W-phase.

The PWM signals are pulse-like signals that can be high (indicating on-state, that is close) or low (indicating off-state, that is open). The width of a pulse in which an on-state continues is called a pulse width. Because the inverter modules 20 are provided in the inverter unit 2, there are three the switching elements 21 for the same phase and the same arm, as described later. For this reason, the control unit 3 determines a pulse width based on a current that flows when the three switching elements 21 are in on-states. Therefore, the control unit 3 generates the corresponding PWM signal while using the three switching elements 21 as one switching element 21 of a large current capacity.

The surge absorption circuits 4 (surge absorption circuits 4a to 4c) are configured to absorb surge voltages generated in the inverter modules 20 when the inverter unit 2 is operated. The surge absorption circuits 4 are provided for the inverter modules 20 of respective phases, and each of the surge absorption circuits 4 is arranged between a positive terminal 11 and a negative terminal 12 of the capacitor 1. By arranging each of the surge absorption circuits 4 between the positive terminal 11 and the negative terminal 12, the surge absorption circuit 4 prevents a pattern inductance 61, which will be described later, from increasing. However, the arrangement is not limited thereto, and the surge absorption circuit 4 may be arranged between the positive terminal 11 and a ground side terminal of a power terminal 24. The ground side terminal includes a around terminal of a power element involved in power conversion described later. Each of the surge absorption circuits 4 of Embodiment 1 is formed of a snubber resistor 41 (snubber resistors 41a to 41c) and a snubber capacitor 42 (snubber capacitors 42a to 42c). The snubber resistor 41 and the snubber capacitor 42 are connected in series.

The current detection devices 5 (current detection devices 5a to 5c) are configured to detect currents flowing in the inverter unit 2. The current detection devices 5 of Embodiment 1 are installed for the respective inverter modules 20. The surge absorption circuits 4 and the current detection devices 5 will be further described below.

FIG. 2 is a diagram illustrating an internal configuration of an inverter module in the power converter according to Embodiment 1. The inverter modules 20a to 20c have the same configuration. The inverter modules 20 each include switching elements 21, a driving circuit 22, a control terminal 23, and a power terminal 24. Each of the inverter modules 20 includes, as the switching elements 21, a switching element 21a, a switching element 21b, a switching element 21c, a switching element 21d, a switching element 21e, and a switching element 21f. The switching element 21a, the switching element 21c, and the switching element 21e form an upper arm. The switching element 21b, the switching element 21d, and the switching element 21f form a lower arm. As shown in FIG. 2, in each of the inverter modules 20 of Embodiment 1, a plurality of the switching elements 21 are arranged in parallel and constitute an upper arm and a lower arm. Therefore, even when each of the switching elements 21a to 21f has a small current capacity, by driving the three switching elements 21 of the upper arm in parallel and those of the lower arm in parallel, driving of the switching elements 21 in a large current capacity can be achieved.

Next, materials for the switching elements 21 provided in the inverter modules 20 will be explained. Elements of any materials may be used as the switching elements 21. For example, wide-bandgap semiconductors, such as gallium nitride (GaN), silicon carbide (SiC), and diamond, may be used. By using such wide-bandgap semiconductors as the switching elements 21, a high break-down voltage and a high allowable current density can be achieved. As a result, the modules can be made smaller. Such a wide-bandgap semiconductor has a high heat resistance. In addition, a wide-bandgap semiconductor works at a high switching speed, and a loss to be generated in switching is small. For this reason, a heat-transfer fin of a heat-transfer unit (not shown) provided in each of the inverter modules 20 can be made smaller.

The driving circuit 22 is configured to generate, based on PWM signals from the control unit 3, PWM signals for element for driving the switching element 21a, the switching element 21b, the switching element 21c, the switching element 21d, the switching element 21e, and the switching element 21f. Specifically, the driving circuit 22 of the inverter module 20 corresponding to the U-phase of the motor 200 makes three duplicates of the PWM signals Up and Un transmitted from the control unit, and amplifies the duplicates to generate PWM signals for element. The driving circuit 22 transmits PWM signals for element, which are made by duplicating the PWM signal Up, to the switching element 21a, the switching element 21c, and the switching element 21e forming the upper arm. The driving circuit 22 transmits PWM signals for element, which are made by duplicating the PWM signal Un, to the switching element 21b, the switching element 21d, and the switching element 21f forming the lower arm. The control terminal 23 is one of the terminals that the inverter module 20 use for inputting and outputting signals, and is a terminal that connects the driving circuit 22 in the inverter module 20 to an external control system equipment, such as the control unit 3. The power terminal 24 is a terminal that connects the switching elements 21, which are power elements, in the inverter modules 20 to an external power system equipment, such as the motor 200. A positional relationship between the control terminal 23 and the power terminal 24 will be described later.

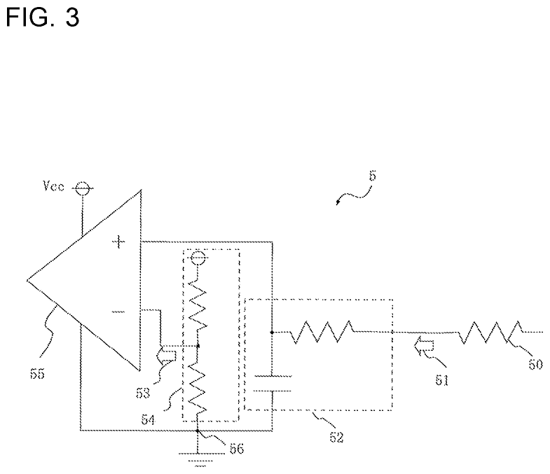

FIG. 3 is a diagram illustrating an example of a configuration of a current detection device according to Embodiment 1. The current detection device 5 of Embodiment 1 includes a current detection unit 50, a low-pass filter circuit 52, a set voltage generation circuit 54, and a comparator 55.

The current detection unit 50 detects a current flowing the inverter module 20 of the corresponding phase, and passes the current as a detection voltage 51. The current detection unit 50 is arranged, for each of the inverter modules 20, between a terminal on a ground side of the power terminal 24 and the negative terminal 12. The terminal on the ground side of the power terminal 24 is a reference potential for power system equipment involving power supply. Here, in Embodiment 1, a shunt resistor is used as the current detection unit 50, as shown in FIG. 3. However, the current detection unit 50 is not limited to a shunt resistor. For example, a current sensor using a magnetic core, a magneto-impedance (MI) sensor using an MI effect, a magnetoresistive (MR) sensor using an MR effect, or a coreless sensor, including a current sensor, using a Hall effect may be used as the current detection unit 50.

The low-pass filter circuit 52 of Embodiment 1 includes a resistor and a capacitor, and is configured to smooth the detection voltage 51. The set voltage generation circuit 54 includes a resistor, and is configured to generate a set voltage 53 that is set as a comparison reference for comparison with the detection voltage 51. The comparator 55 functioning as a comparator compares the detection voltage 51 with the set voltage 53 to detect an overcurrent. In Embodiment 1, as shown in FIG. 3, the set voltage generation circuit 54 is arranged in close proximity to the comparator 55 and the set voltage 53 is generated near the comparator 55. However, the configuration is not limited to the close arrangement. Furthermore, in this case, the set voltage generation circuit 54 is formed by using a voltage-dividing resistor, but is not limited thereto. For example, the set voltage generation circuit 54 may include a shunt regulator or a Zener diode. In addition, the set voltage generation circuit 54 may be formed by using a diode and may be configured to generate a set voltage 53 by using voltage drop.

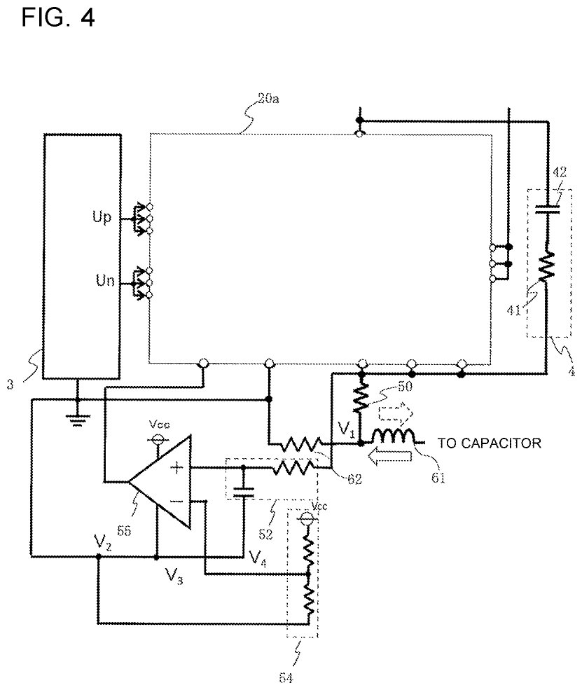

FIG. 4 is a diagram illustrating an earth point according to Embodiment 1. As shown in FIG. 4, in the power converter 100 of Embodiment 1, not only devices in the current detection devices 5 but also the control unit 3 are connected at one point to the ground at an earth point 56 to have the same reference potential (ground or GND). Now, a reason why devices of the power converter 100 are connected at one point at the earth point 56 will be explained. FIG. 4 shows the inverter module 20a corresponding to the U-phase and devices associated therewith when a current flows in a direction indicated by a broken line arrow. When a current flows in the direction indicated by the broken line arrow in FIG. 4, a voltage V1 is generated from the pattern inductance 61 of wiring of a printed substrate. When a single-pair inverter having a small capacity is used, the voltage V1 generated from the pattern inductance 61 is reduced to a negligible small level by a pattern impedance 62 of wiring of the printed substrate. However, when a plurality of switching elements 21 are arranged in parallel to form a parallel inverter having a large current capacity, as in Embodiment 1, a current flowing therein becomes so large that the voltage V1 cannot be reduced by the pattern impedance 62 alone. In addition, the voltage V1 has some effects on the reference potential of the control unit 3. When connection is not made at one point at the earth point 56, a reference potential of the low-pass filter circuit 52, that of the comparator 55, and that of the set voltage 53 has a potential difference V2, a potential difference V4, and a potential difference V3, respectively, with respect to the reference potential of the control unit 3. These potential differences cause early shutoffs and erroneous detections of overcurrent. When connection is made at one point at the earth point 56, as shown in FIG. 4, no potential difference is generated between the reference potential of the control unit 3 and the reference potential of each of the low-pass filter circuit 52, the set voltage 53, and the comparator 55, and thus early shutoffs and erroneous detections of overcurrent can be prevented.

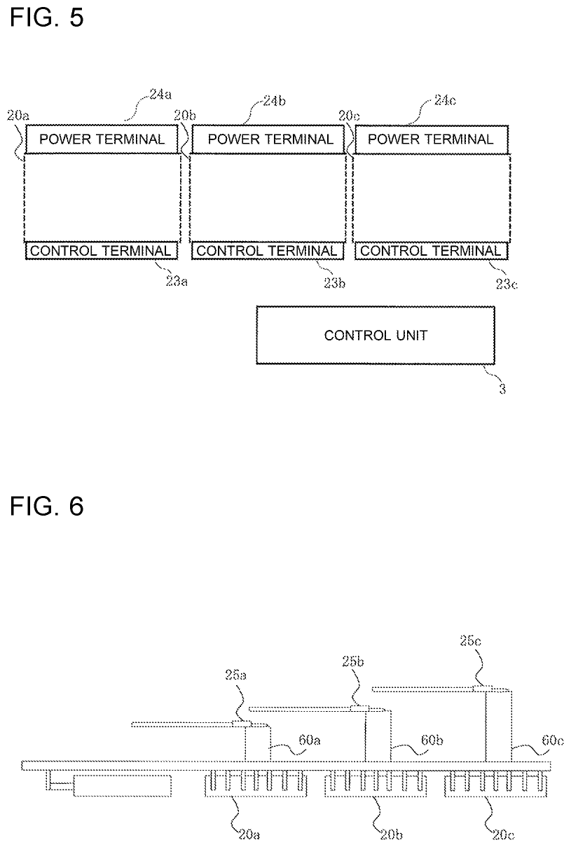

FIG. 5 is a diagram illustrating an arrangement relationship between the inverter modules and the control unit according to Embodiment 1. Next, arrangement of the inverter modules 20 and the control unit 3 will be explained. In this case, enclosures of the inverter modules 20 have a rectangular cuboid shape. The rectangular cuboid shape includes a cubic shape. A face of the enclosure that is in contact with the substrate on which wiring is printed is a bottom face, and faces thereof crossing the bottom face in a perpendicular direction are side faces. On sides of two long-side side faces opposites each other, among the four side faces, the control terminal 23 (control terminals 23a to 23c) and the power terminal 24 (power terminals 24a to 24c) are arranged.

Furthermore, as shown in FIG. 5, the inverter modules 20a to 20c are arranged in parallel so that one short-side side face of one enclosure faces that of another enclosure. In addition, the inverter modules 20a to 20c are arranged so that the long-side side faces at which the control terminals 23 are installed are placed on the one same side and the long-side side faces at which the power terminals 24 are installed are placed on the other same side. The control terminals 23 are arranged so as to face the control unit 3. Because the control terminals 23 are arranged on the long-side side faces of one side and the power terminals 24 are arranged on the long-side side faces of the other side, wiring of control side and wiring of power element side can be arranged separately at the inverter modules 20 as a boundary. As a result, an influence of a noise, which is generated by a large current flowing in the power terminals 24, on devices of the control side can be reduced, and malfunction of the peripheral circuits thus can be prevented.

In FIG. 5, the control terminals 23 and the power terminals 24 are arranged on the two long-side side faces, but the configuration is not limited thereto. For example, the control terminals 23 and the power terminals 24 may be arranged on the sides of two short-side side faces. In this case, the inverter modules 20a to 20c are arranged so that the long-side side faces thereof face each other. In addition, the short-side side faces at which the control terminals 23 are installed are placed so as to face the control unit 3. Furthermore, the four side faces of each of the inverter modules 20 may have a same side length.

FIG. 6 is a diagram illustrating a relationship of the inverter terminals in terms of their output terminals and terminal blocks according to Embodiment 1. An output terminal 25a, an output terminal 25b, and an output terminal 25c are included in the respective power terminals 24, and supply a power from the inverter modules 20a to 20c, respectively, to the respective phases of the motor 200. A terminal block 60a, a terminal block 60b, and a terminal block 60c are blocks to which the output terminals 25a to 25c are respectively attached. Because, on the printed substrate, the inverter modules 20a to 20c are arranged in parallel, the respective output terminals 25 are positioned close to each other. Consequently, wirings connecting to the respective phases of the motor 200 come close to each other, and thus a noise generated due to driving of one module may affect the wiring of another module. In addition, heat generated due to output from the inverter modules 20 may be accumulated in one part in an enclosure of the power converter.

Therefore, in the power converter 100, the heights of the terminal blocks 60, to which the respective output terminals 25 are attached, are made different from each other. When the heights of the terminal blocks 60 are different from each other, the lengths of wirings connecting to the respective phases of the motor 200 can be made to have a short and uniform length. As a result, an influence of a noise can be suppressed and accumulation of heat can be prevented.

As described above, according to the power converter 100 of Embodiment 1, the surge absorption circuit 4 and the current detection device 5 are provided for each of the inverter modules 20. With this configuration, even when the size of the power converter 100 is increased and an amount of wiring and the pattern inductance 61 of the wiring are thus increased, the surge absorption circuit 4 and the current detection device 5 can be set corresponding to a noise generated in the corresponding inverter module 20. As a result, as the whole power converter 100, a noise resistance can be prevented from lowering and malfunction of circuits can be prevented from occurring. Furthermore, because the comparator 55 is provided in each of the current detection devices 5, an overcurrent can be detected by comparing the detection voltage 51, which is based on a current detected by the current detection unit 50, with the set voltage 53, which is generated by the set voltage generation circuit 54. As a result, protection of the inverter modules 20 can be made possible.

Each of the inverter modules 20 includes the control terminal 23 on the side of one side face and the power terminal 24 on the side of the opposite side face. The control terminals 23 of the inverter modules 20 are aligned on one side, and the power terminals 24 of the inverter modules 20 are aligned on the other side. The inverter modules 20a to 20c are arranged in parallel so that one side face, on which no terminal is installed, of one inverter module 20 faces one side face of another inverter module 20. With this configuration, wiring of control system equipment side and wiring of power system equipment side can be arranged separately from each other. Thus, an influence of a noise generated in the power system equipment and the wiring thereof on the control system equipment and the wiring thereof can be reduced. In addition, because the switching elements 21a to 21f in each of the inverter modules 20 are formed of wide-bandgap semiconductors, the switching elements 21 having a high break-down voltage, a high allowable current density, a high heat resistance, and a high switching speed can be attained.

Furthermore, the control terminals 23 of the inverter modules 20 are arranged so as to face the control unit 3. Therefore, the length of wiring between each of the control terminals 23 and the control unit 3 can be reduced, and thus a noise reduction can be achieved.

Moreover, the devices in each of the current detection devices 5 and the control unit 3 are connected at one point at the earth point 56 to have the same reference potential (GND). Therefore, no potential difference is generated among the reference potentials of the devices, and thus early shutoffs and erroneous detections can be prevented.

In addition, by making the heights of the terminal blocks 60, to which the respective output terminals 25 are attached, different from each other, the lengths of wirings connecting to the respective phases of the motor 200 can be made to have a short and uniform length. Thus, an influence of a noise can be suppressed and accumulation of heat can be prevented.

### Embodiment 2

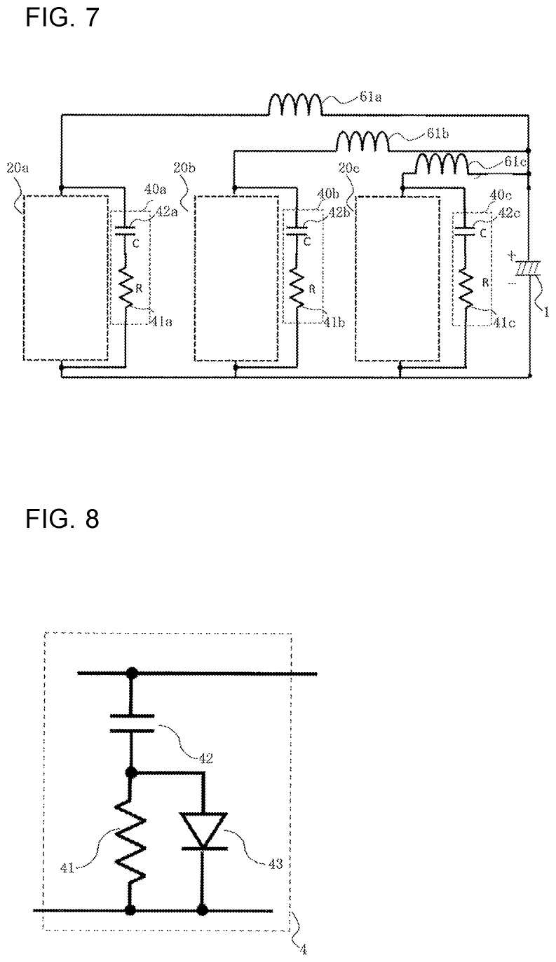

FIG. 7 is a diagram illustrating pattern inductances between a capacitor and inverter modules in a power converter according to Embodiment 2. When a length or a path of wiring between a capacitor 1 and the inverter module 20 is different among the inverter modules 20a to 20c, a pattern inductance 61a, a pattern inductance 61b, and a pattern inductance 61c of the respective wirings are different from each other.

For this reason, in Embodiment 2, each of the surge absorption circuits 4 provided for the corresponding inverter module 20 has a value of a surge absorption circuit constant 40 adapted for the corresponding pattern inductance 61. In this case, a time constant for the surge absorption circuit 4 installed corresponding to the inverter module 20a is a surge absorption circuit constant 40a. A time constant for the surge absorption circuit 4 installed corresponding to the inverter module 20b is a surge absorption circuit constant 40b. A time constant for the surge absorption circuit 4 installed corresponding to the inverter module 20c is a surge absorption circuit constant 40c.

For example, suppose that values of the pattern inductances 61 has a relationship of the pattern inductance 61a>the pattern inductance 61b>the pattern inductance 61c. At this time, the values of the surge absorption circuit constants 40 of the surge absorption circuits 4 are adjusted so that a relationship of the surge absorption circuit constant 40a>the surge absorption circuit constant 40b>the surge absorption circuit constant 40c is obtained. The surge absorption circuit constant 40 can be adjusted by changing at least one of a capacity of the snubber capacitor 42 and a value of the snubber resistor 41.

As described above, in the power converter 100 of Embodiment 2, the surge absorption circuits 4 are configured so as to have different surge absorption circuit constants 40 each corresponding to the pattern inductance 61 between the capacitor 1 and the corresponding inverter module 20. Thus, a surge voltage to be absorbed by each of the surge absorption circuits 4 can be made equal among the surge absorption circuits 4. Therefore, an imbalance between a voltage stress applied to each of the inverter modules 20 and a voltage stress applied to each of the surge absorption circuits 4 can be prevented from occurring, and as a result, the reliability of the whole device can be improved.

### Embodiment 3

FIG. 8 is a diagram illustrating a configuration of a surge absorption circuit according to Embodiment 3. In Embodiment 1, an example of the surge absorption circuit 4 in which the snubber resistor 41 and the snubber capacitor 42 are connected in series is explained. A surge absorption circuit 4 of Embodiment 3 includes a snubber diode 43. The snubber diode 43 is connected in parallel to both ends of the snubber resistor 41, which is connected in series to the snubber capacitor 42. The surge absorption circuit 4 is not limited to the configuration of FIG. 1 or FIG. 8. The surge absorption circuit 4 may be configured by combining and connecting in series or in parallel the snubber resistor 41, the snubber capacitor 42, and the snubber diode 43, which are circuit elements of the surge absorption circuit 4.

### Embodiment 4

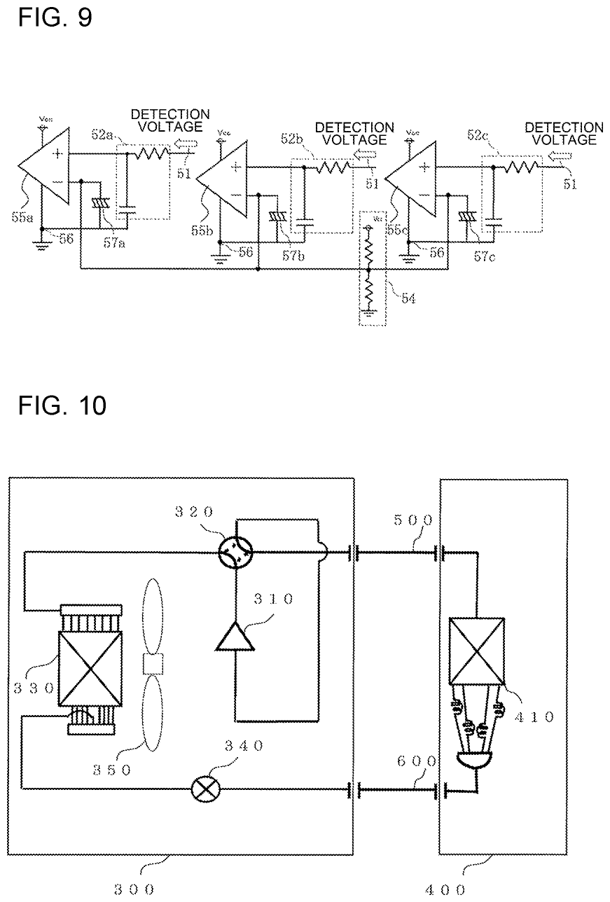

FIG. 9 is a diagram illustrating a current detection device in a power converter according to Embodiment 4. The power converter 100 of Embodiment 1 includes three current detection devices 5, each having the set voltage generation circuit 54. A power converter 100 of Embodiment 4 is configured to include a set voltage generation circuit 54 that is common to three current detection devices 5. In each of the three current detection devices 5 (current detection devices 5a to 5c), an electrolytic capacitor 57 (electrolytic capacitors 57a to 57c) is arranged in close proximity to the comparator 55 (comparators 55a to 55c). Then, the control unit 3, low-pass filter circuits 52 (low-pass filter circuit 52a to 52c), the electrolytic capacitors 57, and the comparators 55 are connected to the ground at one point at the earth point 56 to have the same reference potential. By using the common set voltage generation circuit 54, the circuit configuration can be simplified.

### Embodiment 5

FIG. 10 is a diagram illustrating a configuration example of an air-conditioning apparatus according to Embodiment 5. In this case, FIG. 10 shows an air-conditioning apparatus that cools and heats an air-conditioned space, as an example of a refrigeration cycle apparatus. The components described in FIG. 1 and other drawings perform similar operation in FIG. 10. In the air-conditioning apparatus of FIG. 10, an outdoor unit 300 and an indoor unit 400 are connected by piping by using a gas refrigerant pipe 500 and a liquid refrigerant pipe 600. The outdoor unit 300 includes a compressor 310_{;} a four-way valve 320, an outdoor heat exchanger 330, and an expansion valve 340. The outdoor unit 300 also includes an outdoor side fan 350.

The compressor 310 is driven by rotation of the motor 200 described in Embodiments 1 to 4, and compresses and discharges sucked refrigerant. The power converter 100 described in Embodiments 1 to 4 controls the rotation speed of the motor 200 to change a capacity (an amount of refrigerant sent out per unit time) of the compressor 310. The four-way valve 320 is, for example, a valve that switches between a refrigerant flow for a cooling operation and that for a heating operation.

The outdoor heat exchanger 330 of Embodiment 5 causes heat exchange to be performed between refrigerant and outdoor air. For example, the outdoor heat exchanger 330 functions as an evaporator in a heating operation to evaporate and gasify the refrigerant. The outdoor heat exchanger 330 functions as a condenser in a cooling operation to condense and liquefied the refrigerant. The expansion valve 340, such as an expansion device or a flow control unit, decompresses and thereby expands the refrigerant. For example, when the expansion valve 340 is formed of an electronic expansion valve or a similar valve, an opening degree thereof is controlled based on an instruction from a controller (not shown).

The outdoor side fan 350 is driven by rotation of the motor 200 described in Embodiments 1 to 4, and supplies air to be heat-exchanged with the refrigerant in the outdoor heat exchanger 330. By controlling the rotation speed of the motor 200 by the power converter 100 described in Embodiments 1 to 4, an air volume of the fan can be changed.

Furthermore, the indoor unit 400 includes an indoor heat exchanger 410. The indoor heat exchanger 410 causes heat exchange between air to be air-conditioned and the refrigerant. The indoor heat exchanger 410 functions as a condenser in a heating operation to condense and liquefy the refrigerant. The indoor heat exchanger 410 functions as an evaporator in a cooling operation to evaporate and gasify the refrigerant.

By forming the air-conditioning apparatus as described above and by switching the refrigerant flows by the four-way valve 320 of the outdoor unit 300, a heating operation and a cooling operation can be achieved.

### INDUSTRIAL APPLICABILITY

In Embodiment 5, the air-conditioning apparatus is explained as an example of a refrigeration cycle apparatus, but the refrigeration cycle apparatus is not limited to thereto. The power converter 100 of Embodiments 1 to 4 may be applied to other refrigeration cycle apparatuses, such as a refrigerating machine, a washing and drying machine, a refrigerator, a dehumidifier, a heat pump type water heater, and a showcase.

Furthermore, the power converter 100 may be used in devices, such as a cleaner, a fan motor, a ventilator, a hand dryer, and an induction heat electromagnetic cooking device.

### REFERENCE SIGNS LIST

1: capacitor, 2: inverter unit, 3: control unit, 4, 4a, 4b, 4c: surge absorption circuit, 5, 5a, 5b, 5c: current detection device, 6: voltage detection unit, 7, 8: current detector, 11: positive terminal, 12: negative terminal, 20, 20a, 20b, 20c: inverter module, 21, 21a, 21b, 21c, 21d, 21e, 21f: switching element, 22: driving circuit, 23, 23a, 23b, 23c: control terminal, 24, 24a, 24b, 24c: power terminal, 25, 25a, 25b, 25c: output terminal, 40, 40a, 40b, 40c: surge absorption circuit constant, 41, 41a, 41b, 41c: snubber resistor, 42, 42a, 42b, 42c: snubber capacitor, 43: snubber diode, 50: current detection unit, 51: detection voltage, 52, 52a, 52b, 52c: low-pass filter circuit, 53: set voltage, 54: set voltage generation circuit, 55, 55a, 55b, 55c: comparator, 56: earth point, 57, 57a, 57b, 57c: electrolytic capacitor, 60, 60a, 60b, 60c: terminal block, 61, 61a, 61b, 61c: pattern inductance, 62: pattern impedance, 100: power converter, 200: motor, 300: outdoor unit, 310: compressor, 320: four-way valve, 330: outdoor heat exchanger, 340: expansion valve, 350: outdoor side fan, 400: indoor unit, 410: indoor heat exchanger, 500: gas refrigerant pipe, 600: liquid refrigerant pipe

1. A power converter comprising:
a plurality of inverter modules, each having a plurality of switching elements and each configured to convert a direct current voltage into an alternating current voltage by operations of the switching elements;
a plurality of surge absorption circuits provided corresponding to the plurality of inverter modules and configured to absorb a generated surge voltage;
a plurality of current detection devices provided corresponding to the plurality of inverter modules, the current detection devices each having a current detection unit for detecting a current flowing in the corresponding inverter module, and,
a control unit configured to control driving of the inverter modules, wherein
the current detection devices each include
a filter circuit configured to filter a detection voltage based on a current detected by the current detection unit,
a set voltage generation circuit configured to generate a set voltage, which is a reference for comparison with the detection voltage, and
a comparator configured to compare the detection voltage with the set voltage to detect an overcurrent, and
wherein devices of the current detection devices corresponding to the plurality of inverter modules and the control unit are connected at one point to a ground.

2. The power converter of claim 1, wherein
the plurality of inverter modules each have an enclosure having a rectangular cuboid shape and are arranged in parallel in such a manner that a side face of one enclosure, the side face being on a side where no terminal for connecting wiring is arranged, and that of another enclosure face each other.

3. The power converter of claim 1,
wherein a control terminal provided in each of the inverter modules is arranged so as to face the control unit.

4-5. (canceled)

6. The power converter of claim 1, wherein
output terminals on a power side provided in the respective inverter modules are installed on respective terminal blocks, and
heights of the terminal blocks are different from each other.

7. The power converter of claim 1, wherein
the plurality of surge absorption circuits each have a time constant adapted for the inverter module where the corresponding surge absorption circuit is provided.

8. The power converter of claim 1, wherein
at least one of the switching elements is an element using a wide-bandgap semiconductor.

9. The power converter of claim 1, wherein
a same number of the inverter modules as a number of phases of an electric motor, to which power is supplied, are arranged on a substrate.

10. A refrigeration cycle apparatus comprising:
a power converter of claim 1,
wherein at least one of a compressor and a fan is driven by a power converted by the power converter.

11. An air-conditioning apparatus, wherein
a refrigeration cycle apparatus of claim 10 performs cooling and heating of an air-conditioned space.

12. The power converter of claim 1, wherein, at the earth point, a reference potential of the filter circuit of the current detection device corresponding to the plurality of inverter modules, a referential potential of the set voltage generation circuit and a referential potential of the comparator are the same.

13. The power converter of claim 2, wherein a control terminal provided in each of the inverter modules is arranged so as to face the control unit.

14. The power converter of claim 2, wherein
output terminals on a power side provided in the respective inverter modules are installed on respective terminal blocks, and
heights of the terminal blocks are different from each other.

15. The power converter of claim 3, wherein
output terminals on a power side provided in the respective inverter modules are installed on respective terminal blocks, and
heights of the terminal blocks are different from each other.
